(19) United States
(12) Patent Application Publication
(10) Pub. No.: US 2025/0193728 A1
(43) Pub. Date: Jun. 12, 2025

(54) PACKET TRANSFERRING DEVICE, PACKET TRANSFERRING METHOD AND PROGRAM

(71) Applicant: NEC Corporation, Minato-ku, Tokyo (JP)

(72) Inventor: Kengo NAGATOMO, Tokyo (JP)

(73) Assignee: NEC Corporation, Minato-ku, Tokyo (JP)

(21) Appl. No.: 18/843,766

(22) PCT Filed: Mar. 16, 2022
(86) PCT No.: PCT/JP2022/011776

§ 371 Date: Sep. 4, 2024

(51) Int. Cl. H04W 28/02; H04L 47/6275

(52) U.S. Cl. CPC H04W 28/0236; H04L 47/6275

(57) ABSTRACT

In order to make it possible to transmit packets in an appropriate order, a packet transfer apparatus (1) includes: an acquisition means (11) that acquires an uplink packet received from a terminal apparatus; an allowable time determination means (12) that determines, with reference to time information included in header information of the uplink packet, an allowable time of delay of the uplink packet; and an order determination means (13) that determines, on the basis of the allowable time of delay, an order of transmission of the uplink packet.

### TECHNICAL FIELD

The present invention relates to a packet transfer apparatus, a packet transfer method, and a program.

### BACKGROUND ART

In recent years, various packet transfer apparatuses have been developed each of which performs, in a network slice, a packet transfer process in accordance with QoS (Quality of Service). As a related technology, there are inventions disclosed in Patent Literatures below.

Patent Literature 1 discloses a user data processing apparatus which (i) analyzes a received packet, (ii) identifies a network slice to which the received packet belongs and a class to which the received packet belongs in QoS, and (iii) assigns the received packet to a queue in accordance with a result of analysis of the received packet. Then, the user data processing apparatus acquires a received packet from a queue in a corresponding queue group which que corresponds to each class, and performs a packet transfer process on the acquired received packet in accordance with QoS.

Patent Literature 2 discloses a base station apparatus which (i) measures, with use of a measurement packet having recorded therein time at which the measurement packet is sent out, a delay time spent after the measurement packet is sent out from the transmission apparatus and until the measurement packet is received by a reception section, and (ii) calculates an allowable time which is a value obtained by subtracting the delay time from an upper limit value. Then, the base station transmits a transmission packet to a terminal before the allowable time passes after the transmission packet is received by the reception section.

### CITATION LIST

### Patent Literature

### [Patent Literature 1]

Japanese Patent Application Publication, Tokukai, No. 2021-170729

### [Patent Literature 2]

Japanese Patent Application Publication, Tokukai, No. 2012-119810

### SUMMARY OF INVENTION

### Technical Problem

However, the user data processing apparatus disclosed in Patent Literature 1 does not carry out prioritization of processes by paying attention to delay time. As such, when the user data processing apparatus simultaneously receives a packet having a sufficient delay time and a packet not having a sufficient delay time, the user data processing apparatus may prioritize a transfer process of the packet having a sufficient delay time and consequently fail to meet requirements on delay time that need to be satisfied in 5GS in order to not exceed the delay time between end devices (terminal apparatuses).

The base station disclosed in Patent Literature 2 has a system in which evaluation is made by setting, for each QCI, a target value of delay time assigned to an apparatus included in a network. However, since Patent Literature 2 concerns the base station, an operation carried out in Patent Literature 2 when a target delay time is exceeded differs from an operation carried out in a packet transfer apparatus, and the order of internal processing is not changed. As such, in Patent Literature 2, there is a possibility that data cannot be transmitted within the target delay time.

An example aspect of the present invention has been made in view of the above problems, and an example object thereof is to provide a technique that makes it possible to transfer a packet in an appropriate order.

### Solution to Problem

A packet transfer apparatus in accordance with an example aspect of the present invention includes: an acquisition means that acquires an uplink packet received from a terminal apparatus; an allowable time determination means that determines, with reference to time information included in header information of the uplink packet, an allowable time of delay of the uplink packet; and an order determination means that determines, on the basis of the allowable time of delay, an order of transmission of the uplink packet.

A packet transfer method in accordance with an example aspect of the present invention includes the steps of: acquiring an uplink packet received from a terminal apparatus; determining, with reference to time information included in header information of the uplink packet, an allowable time of delay of the uplink packet; and determining, on the basis of the allowable time of delay, an order of transmission of the uplink packet.

A program in accordance with an example aspect of the present invention causes a computer to carry out: a process of acquiring an uplink packet received from a terminal apparatus; a process of determining, with reference to time information included in header information of the uplink packet, an allowable time of delay of the uplink packet; and a process of determining, on the basis of the allowable time of delay, an order of transmission of the uplink packet.

### Advantageous Effects of Invention

According to an example aspect of the present invention, it is possible to transfer a packet in an appropriate order.

### BRIEF DESCRIPTION OF DRAWINGS

FIG. 1 is a block diagram illustrating an example configuration of a packet transfer apparatus in accordance with a first example embodiment of the present invention.

FIG. 2 is a flowchart illustrating a flow in a packet transfer method that is carried out by the packet transfer apparatus in accordance with the first example embodiment of the present invention.

FIG. 3 is a diagram illustrating an example configuration of a TSN logical bridge including a packet transfer apparatus in accordance with the second example embodiment of the present invention.

FIG. 4 is a diagram illustrating a protocol stack in U-Plane communications.

FIG. 5 is a block diagram illustrating an example configuration of a packet transfer apparatus in accordance with a second example embodiment of the present invention.

FIG. 6 is a diagram for describing time synchronization in UPF/NW-TT.

FIG. 7 is a flowchart illustrating an overall flow in a packet transfer method that is carried out by the packet transfer apparatus in accordance with the second example embodiment of the present invention.

FIG. 8 is a flowchart for describing details of a delay evaluation process illustrated in FIG. 7.

FIG. 9 is a diagram for describing a delay time and a target delay time which are specified by the delay evaluation section.

FIG. 10 is a diagram illustrating an example of target delay times set in a target delay time information table.

FIG. 11 is a flowchart for describing details of a transfer process illustrated in FIG. 7.

FIG. 12 is a diagram illustrating an example configuration of transmission queues of a first transmission section and a second transmission section.

FIG. 13 is a diagram illustrating formats of a GTP-U packet and an IP packet.

FIG. 14 is a diagram illustrating a GTP extension header.

FIG. 15 is a diagram for describing a session process in UPF.

FIG. 16 is a block diagram illustrating a configuration of a computer that functions as a packet transfer apparatus in accordance with each example embodiment.

### EXAMPLE EMBODIMENTS

### First Example Embodiment

The following description will discuss a first example embodiment of the present invention in detail with reference to the drawings. The present example embodiment is an embodiment serving as a basis for an example embodiment described later. Note that reference signs which are indicated in the drawings and are used in this overview are given to elements for convenience as an example for assisting in understanding, and are not intended to limit the present invention to the illustrated aspects. The connection lines between blocks in the drawings and the like referred to in the descriptions below include both a bidirectional relation and a unidirectional relation. The one-way arrows each schematically indicate a flow of a main signal (data) and do not exclude bidirectionality. The input connection point and an output connection point of each of the blocks in the drawings may each be configured to include a port or an interface, and such configurations are not illustrated.

<Packet Transfer Apparatus 1 in Accordance with First Example Embodiment>

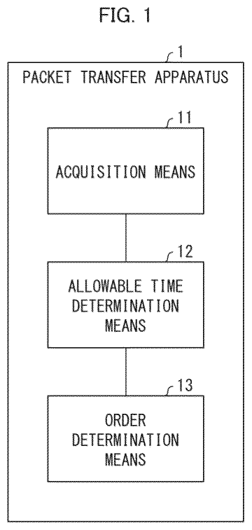

FIG. 1 is a block diagram illustrating an example configuration of a packet transfer apparatus 1 in accordance with a first example embodiment of the present invention. The packet transfer apparatus 1 in accordance with the present example embodiment includes an acquisition means 11, an allowable time determination means 12, and an order determination means 13 as illustrated in FIG. 1.

The packet transfer apparatus 1 is compatible with, for example, a user plane function/network-side TSN translator (UPF/NW-TT), which is one of a plurality of nodes called network functions (NFs) in a fifth generation mobile communication system (5GS).

The acquisition means 11 acquires an uplink packet received from a terminal apparatus. For example, the acquisition means 11 acquires, via a time sensitive networking (TSN) network or a next generation NodeB (gNB), an uplink packet received from a terminal apparatus.

TSN is a set of standardized technologies defined by IEEE 802.1Q in order to realize definitive messaging in standard Ethernet (registered trademark). The TSN technologies are managed in an integrated fashion and use time scheduling to guarantee delivery and minimum jitter with respect to real-time applications which require certainty.

The allowable time determination means 12 determines, with reference to time information included in header information of the uplink packet, an allowable time of delay of the uplink packet. For example, the allowable time determination means 12 refers to time information included in a GPRS tunneling protocol (GTP) extension header and determines an allowable time of delay of the uplink packet. The allowable time of delay is a value that indicates the degree of sufficiency of delay time in relation to target delay time. For example, the allowable time of delay is a value obtained by subtracting the current delay time from the target delay time.

GTP is a protocol standardized by GPRS in 1998, and is now also used in a user plane in 5GC. In accordance with the advancement of networks, some extensions were required in GTP in order to support reference points of N9 and N3 in 5GC.

As increasingly more complex QoS functions are introduced to 5GC, notification of specific information for each packet is necessary. In a previous-generation mobile network, traffics can be distinguished from each other by differing tunnel end point identifiers (TEIDs) but cannot be distinguished from each other in terms of packets.

Extension of QoS in 5GC means that it is necessary for UPF of gNodeB to set a QoS flow identifier for each packet. It is necessary, for each packet, to include a delay measurement or a signal that indicates that reflective QoS is in use. For this reason, it is necessary to extend GTP. GTP supports extension headers and is utilized in order to add a PDU session container to an extension header of a GTP packet.

The time information include, for example, (i) transmission time at which the uplink packet is transmitted by the gNB and (ii) a result of measurement of delay of the uplink packet in a path from user equipment (UE: terminal apparatus) to the gNB, the transmission time and the result of measurement of delay being indicated by UL Sending Timestamp (UL transmission time stamp) and UL Delay Result (UL delay result), respectively, in UL PDU SESSION INFORMATION (PDU Type 1) in the GTP extension header.

The order determination means 13 determines, on the basis of the allowable time of delay, an order of transmission of the uplink packet. For example, the order determination means 13 sets an order of transmission of a packet having a relatively short allowable time of delay to be early, and sets an order of transmission of a packet having a relatively long allowable time of delay to be late.

### <Example Advantage of Packet Transfer Apparatus 1>

As described above, according to the packet transfer apparatus 1 in accordance with the present example embodiment, the order determination means 13 determines an order of transmission of an uplink packet on the basis of an allowable time of delay. This makes it possible to transfer packets in an appropriate order on the basis of time information of the packets.

### <Flow in Packet Transfer Method Carried Out by Packet Transfer Apparatus 1>

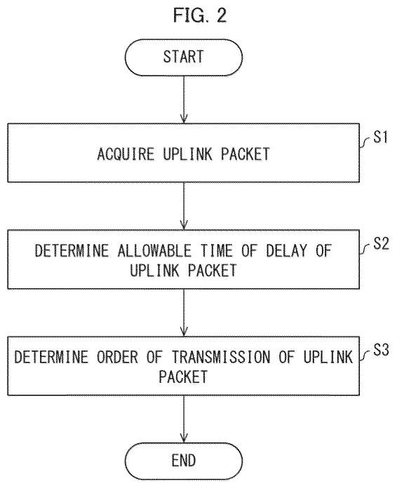

The following description will discuss a flow in a packet transfer method that is carried out by the packet transfer apparatus 1 configured as described above, with reference to FIG. 2. FIG. 2 is a flowchart illustrating a flow in the packet transfer method. As illustrated in FIG. 2, the packet transfer method includes steps S1 to S3.

First, the acquisition means 11 acquires an uplink packet received from a terminal apparatus (S1). For example, the acquisition means 11 acquires, via a TSN network or a gNB, an uplink packet received from the terminal apparatus.

Subsequently, the allowable time determination means 12 determines, with reference to time information included in header information of the uplink packet, an allowable time of delay of the uplink packet (S2). For example, the allowable time determination means 12 refers to time information included in a GTP extension header and determines an allowable time of delay of the uplink packet.

Lastly, the order determination means 13 determines, on the basis of the allowable time of delay, an order of transmission of the uplink packet (S3). For example, the order determination means 13 sets an order of transmission of a packet having a relatively short allowable time of delay to be early, and sets an order of transmission of a packet having a relatively long allowable time of delay to be late.

### <Example Advantage of Packet Transfer Method>

As described above, according to the packet transfer method in accordance with the present example embodiment, the order determination means 13 determines an order of transmission of an uplink packet on the basis of an allowable time of delay. This makes it possible to transfer packets in an appropriate order on the basis of time information of the packets.

### Second Example Embodiment

The following description will discuss a second example embodiment of the present invention in detail with reference to the drawings. Note that members having functions identical to those of the respective members described in the first example embodiment are given respective identical reference numerals, and a description of those members is omitted as appropriate.

### <Example Configuration of TSN Logical Bridge 100>

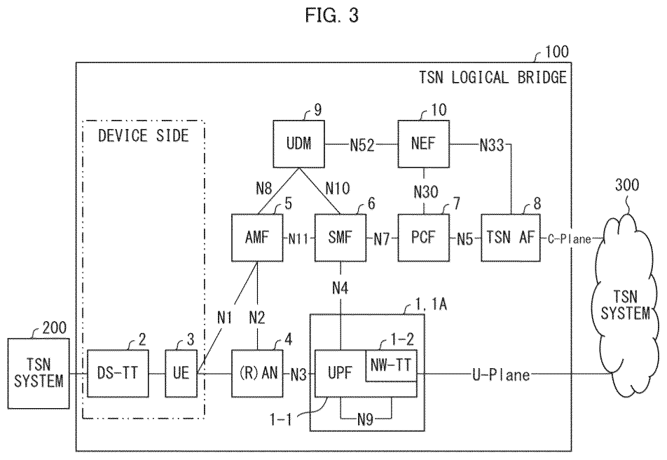

FIG. 3 is a diagram illustrating an example configuration of a TSN logical bridge 100 including a packet transfer apparatus 1A in accordance with the second example embodiment of the present invention. The TSN logical bridge 100 includes a plurality of nodes called network functions (NFs) and inter-NF interfaces N1 to N5, N7 to N11, N30, N33, and N52.

The TSN logical bridge 100 includes a UPF/network side-TSN translator (UPF/NW-TT) 1, a device side-TSN translator (DS-TT) 2, UE 3, a radio access network ((R)AN) 4, access and mobility function (AMF) 5, Session Management Function (SMF) 6, policy control function (PCF) 7, TSN application function (TSN AF) 8, user data management (UDM) 9, and a network exposure function (NEF) 10.

UPF 1-1 is an NF that functions as an external protocol data unit (PDU) session point that interconnects with a data network (DN), and carries out, for example, packet routing and forwarding.

A NW-TT 1-2 port supports connection to a TSN system 300, and transfers the traffic to an appropriate output port on the basis of traffic transfer information.

A port of the DS-TT 2 is associated with a PDU session port that provides connection to the TSN system 200. There is only one PDU session for each port of the DS-TT 2. All of the PDU sessions connected to the same TSN network via the specific UPF 1-1 are grouped in a single 5GS bridge.

The UE 3 is connected to the RAN or access network (AN) 4 and to the AMF 5. The UE 3 corresponds, for example, to the terminal apparatus.

The RAN 4 is a base station that uses a new radio access technology (RAT). The AN 4 is a base station that uses a non-3GPP access. Examples of such a base station include a WiFi (registered trademark) access point.

The AMF 5 is an NF that provides, for example, authentication, permission, and mobility management of the UE 3, and controls the SMF 6. The SMF 6 is an NF that is responsible for, for example, session management of the UE 3, assignment of an IP address, and selection and control of the UPF/NW-TT 1 for data transfer. In a case where the UE 3 establishes a plurality of sessions, the AMF 5 can assign different SMFs 6 to the respective sessions so that the SMFs 6 independently manage the sessions and use different functions for the respective sessions. In the 5GC, management related to the UE 3 is carried out by a single AMF 5, and traffic is handled by an SMF 6 for each individual network slice.

The PCF 7 is an NF that determines policies related to mobility management and session management for causing the AMF 5 and the SMF 6 to properly operate. The TSN AF 8 is an NF that provides the PCF 7, which carries out policy control, with information pertaining to packet flow in order to support quality of service (QOS). The PCF 7 determines policies related to mobility management and session management on the basis of the information pertaining to packet flow provided by the TSN AF 8.

The UDM 9 is an NF that carries out, for example, storage and management of contract information of the UE 3. The NEF 10 is an NF that discloses a series of management functions such as addition, deletion, and various changes of a group or a member and a function of dynamically managing group data.

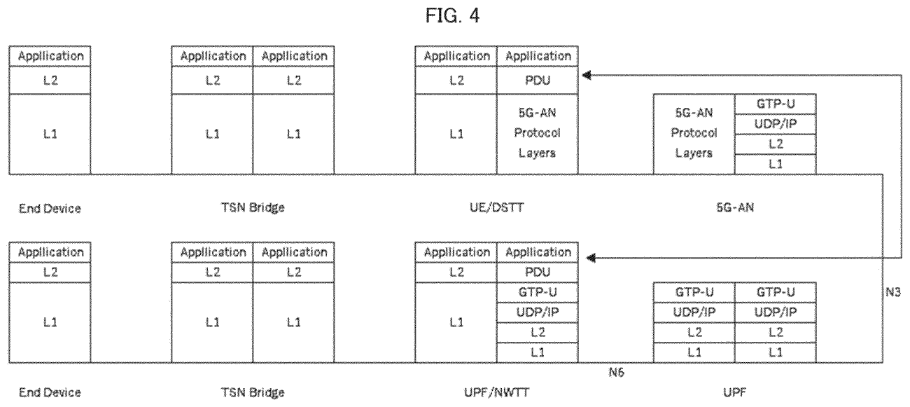

FIG. 4 is a diagram illustrating a protocol stack in U-Plane communications. For example, the UE/DSTT shown in FIG. 4 indicates a protocol stack of the DS-TT 2 and the UE 3 on the device side illustrated in FIG. 3. 5G-AN shown in FIG. 4 indicates a protocol stack of the AN 4 illustrated in FIG. 3. UPF shown in FIG. 4 indicates a protocol stack of the UPF 1-1 illustrated in FIG. 3. UPF/NWTT shown in FIG. 4 indicates a protocol stack of the UPF/NW-TT 1 illustrated in FIG. 3.

<Packet Transfer Apparatus 1A in Accordance with Second Example Embodiment>

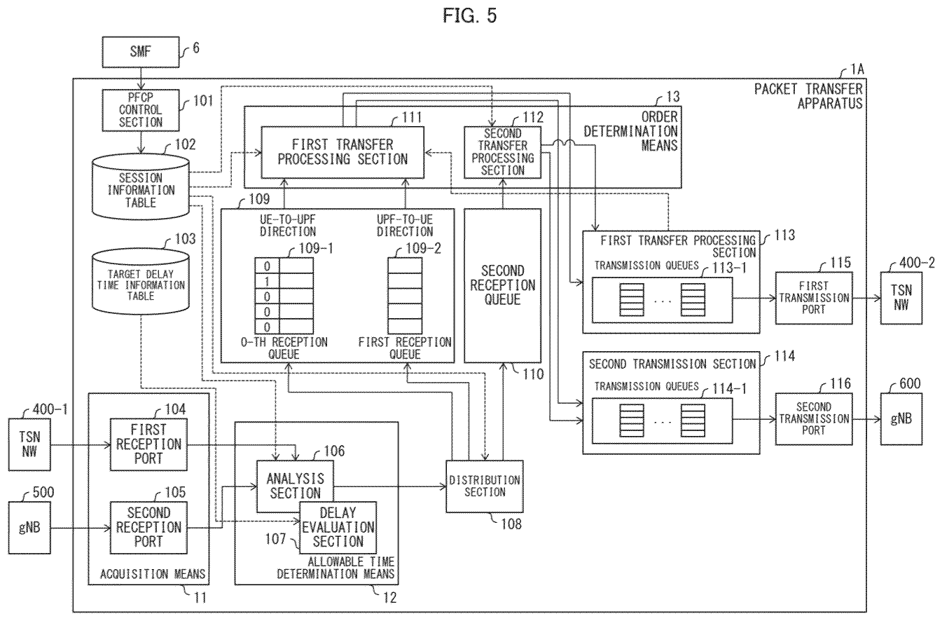

FIG. 5 is a diagram illustrating a configuration of the packet transfer apparatus 1A in accordance with the second example embodiment of the present invention. As illustrated in FIG. 5, the packet transfer apparatus 1A in accordance with the present example embodiment includes an acquisition means 11, an allowable time determination means 12, an order determination means 13, a packet forwarding control protocol (PFCP) control section 101, a session information table 102, a target delay time information table 103, a distribution section 108, a reception queue 109 for low delay, a reception queue 110 for non-low delay, a first transmission section 113, a second transmission section 114, a first transmission port 115, and a second transmission port 116.

The acquisition means 11 includes a first reception port 104 and a second reception port 105. The allowable time determination means 12 includes an analysis section 106 and a delay evaluation section 107. The order determination means 13 includes a first transfer processing section 111 and a second transfer processing section 112.

The first reception port 104, the second reception port 105, the first transmission port 115, and the second transmission port 116 are each constituted by an Ethernet (registered trademark) interface port.

The PFCP control section 101, upon reception of a PFCP signal from the SMF 6, stores PFCP information in the session information table 102. The session information table 102 is a table for managing session information such as PFCP information. The target delay time information table 103 is a table for managing a target delay time of a packet.

The analysis section 106 analyzes a header of a received packet and specifies, on the basis of the session information such as PFCP information stored in the session information table 102, an action to be taken with respect to the received packet. Note that the analysis section 106 will be described later in detail.

The delay evaluation section 107 carries out, for each QoS flow, evaluation of delay time with respect to a packet received from the terminal apparatus. In a case where the delay evaluation section 107 finds out, as a result of evaluation of a QoS flow, that the QoS flow does not allow for a sufficient delay time, the delay evaluation section 107 records information to that effect in the session information table of the packet. Note that the delay evaluation section 107 will be described later in detail.

The distribution section 108 distributes packet data, in the unit of one packet at a time, to either the reception queue 109 or the reception queue 110 on the basis of the result of analysis of the header. Specifically, the distribution section 108 stores low-delay packet data in the reception queue 109 for low delay and stores non-low delay packet data in the reception queue 110 for non-low delay.

The reception queue 109 is a que for temporarily storing therein low-delay packet data that has not been subjected to processing by the first transfer processing section 111. The reception queue 109 has a data structure having a flag indicating that there is not a sufficient delay time allowed. The distribution section 108 sets a flag “1” for a packet corresponding to a QoS flow that does not allow for a sufficient delay time. Note that the reception queue 109 has a 0-th reception queue 109-1 for a direction from the UE 3 to the UPF 1-1 and a first reception queue 109-2 for a direction from the UPF 1-1 to the UE 3.

The second reception queue 110 is a que for temporarily storing therein non-low delay packet data that has not been subjected to processing by the second transfer processing section 112.

The first transfer processing section 111 takes out a packet from the reception queue 109 for low delay, replaces the header with a header suitable for a network to which the packet is to be transmitted, and stores the packet in a transmission queue in the first transmission section 113 or the second transmission section 114.

The second transfer processing section 112 takes out a packet from the reception queue 110 for non-low delay, replaces the header with a header suitable for a network to which the packet is to be transmitted, and stores the packet in a transmission queue in the first transmission section 113 or the second transmission section 114.

The first transmission section 113 has transmission queues 113-1 compatible with IEEE 802.1Q and transmits, via the first transmission port 115 and a TSN network 400-2, data stored in the transmission queues 113-1.

The second transmission section 114 has a transmission queue 114-1 compatible with IEEE 802.1Q and transmits, via the second transmission port 116 and a gNB 600, data stored in the transmission queue 114-1.

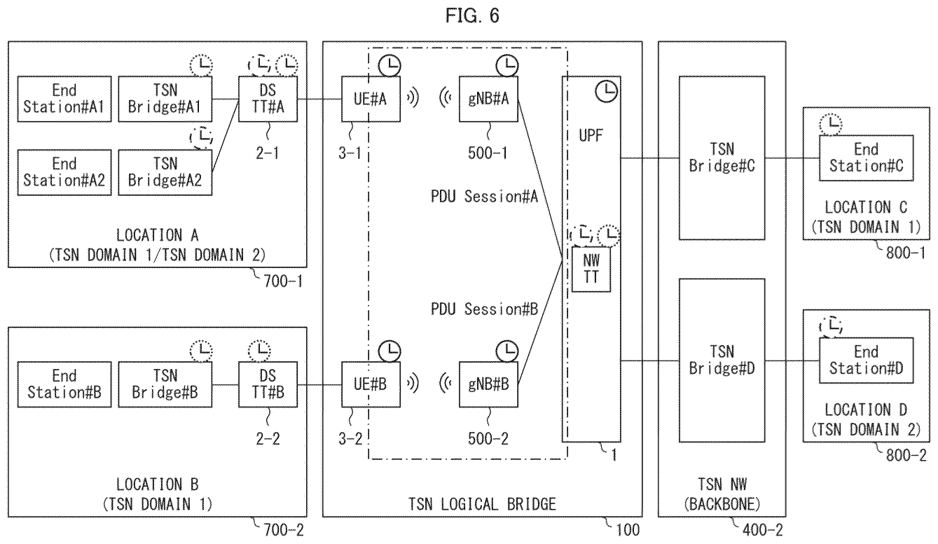

FIG. 6 is a diagram for describing time synchronization in the UPF/NW-TT 1. The UPF 1-1 carries out time synchronization between apparatuses in a 5GS network. In FIG. 6, the UPF 1-1 carried out time synchronization among UE #A 3-1, gNB #A 500-1, and the UPF 1-1 and time synchronization among UE #B 3-2, gNB #B 500-2, and the UPF 1-1.

Further, the NW-TT 1-2 carries out time synchronization between (i) TSN domains 1 in a location A 700-1 and a location B 700-2 and (ii) a domain 1 in a location C 800-1. Similarly, the NW-TT 1-2 carries out time synchronization between a TSN domain 2 in the location A 700-1 and a domain 2 in a location D 800-2.

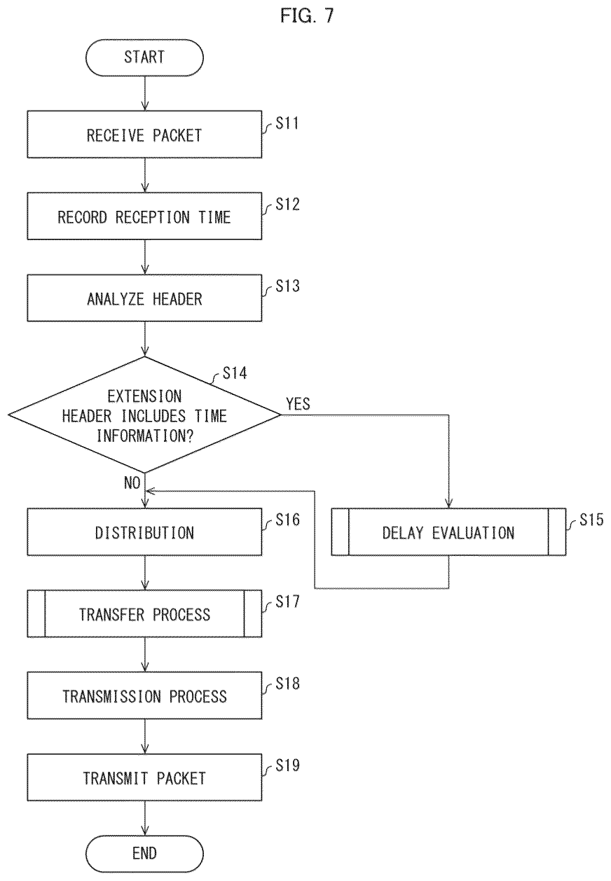

FIG. 7 is a flowchart illustrating an overall flow in a packet transfer method that is carried out by the packet transfer apparatus 1A in accordance with the second example embodiment of the present invention. First, the acquisition means 11 acquires uplink packets respectively received by the first reception port 104 and the second reception port 105 (S11). Then, the acquisition means 11 records reception times at which the uplink packets are respectively received (S12).

Subsequently, the analysis section 106 analyzes a header of each acquired uplink packet and specifies, with reference to PFCP session information stored in the session information table 102, an action to be taken with respect to the uplink packet (S13). Specifically, in order to carry out processes respectively equivalent to PFCP session look up and PDR look up defined under TS29.244 and to carry out distribution for each slice, the analysis section 106 specifies a slice to which the uplink packet belongs.

Subsequently, the analysis section 106 determines whether or not the header of the uplink packet includes transmission time at which the uplink packet is transmitted by the gNB 500 and a result of measurement of delay of the uplink packet in a path from the UE 3 to a gNB 500, the transmission time and the result of measurement of delay being indicated by the UL transmission timestamp and the UL delay result, respectively, in UL PDU SESSION INFORMATION (PDU Type 1) in the GTP extension header (S14).

In a case where the header includes the transmission time at which the uplink packet is transmitted by the gNB 500 and the result of measurement of delay of the uplink packet in the path from the UE 3 to the gNB 500 (S14, Yes), the delay evaluation section 107 carries out, for each QoS flow, evaluation of delay time with respect to the uplink packet transmitted from the UE 3. Then, in a case where the delay evaluation section 107 finds out, as a result of the evaluation of delay time, that the QoS flow does not allow for a sufficient delay time, the delay evaluation section 107 records information to that effect in a corresponding packet stored in the session information table 102 (S15), and the process proceeds to a step S16. Note that the delay evaluation process (S15) will be described later in detail.

In the step S16, the distribution section 108 distributes packet data, in the unit of one packet at a time, to either the reception queue 109 or the reception queue 110 on the basis of the result of analysis of the header. Specifically, the distribution section 108 stores low-delay packet data in the reception queue 109 for low delay and stores non-low delay packet data in the reception queue 110 for non-low delay. At this time, the distribution section 108 refers to the session information table 102 and sets a flag “1” for a packet corresponding to a QoS flow that does not allow for a sufficient delay time.

Subsequently, the first transfer processing section 111 takes out, in the unit of a plurality of packets (e.g. 16 packets) at a time, the packet data stored in the reception queue 109, and stores the packet data in the first transmission section 113 or the second transmission section 114. At this time, in a case where a flag “1” indicating that the QoS flow does not allow for a sufficient delay time is set, the first transfer processing section 111 reverses the order of the packet data (S17). Note that the transfer process (S17) will be described later in detail.

Subsequently, the first transmission section 113 or the second transmission section 114 takes out packet data from a transmission queue 113-1 or a transmission queue 114-1 in accordance with a degree of priority, and carries out a transmission process of the packet data (S18). Lastly, the first transmission port 115 or the second transmission port 116 transmits the uplink packet to the TSN network 400-2 or the gNB 600 (S19).

### <Details of Delay Evaluation Process (S15)>

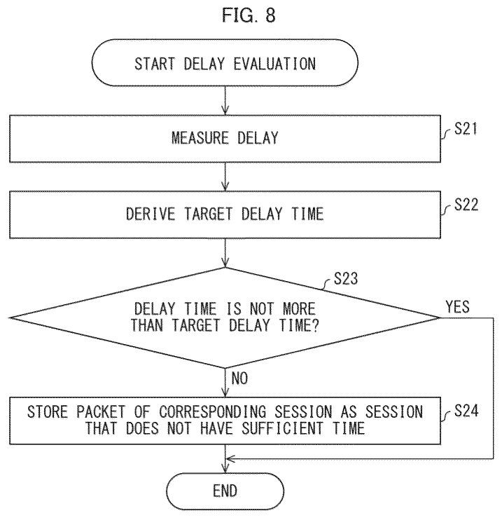

FIG. 8 is a flowchart for describing details of the delay evaluation process (S15) illustrated in FIG. 7. Firstly, the allowable time determination means 12 specifies a first delay time with reference to UL delay result information included in the header information, the first delay time being a time of delay of the uplink packet in a path from the terminal apparatus to the base station.

Specifically, the delay evaluation section 107 of the allowable time determination means 12 specifies the first delay time with reference to a result of measurement of delay of the uplink packet in a path from the UE (terminal apparatus) 3 to the gNB 500, the result of measurement of delay being indicated by UL Delay Result (UL delay result) in UL PDU SESSION INFORMATION (PDU Type 1) in the GTP extension header.

Further, the allowable time determination means 12 specifies a second delay time, which is a time of delay of the uplink packet in a path from the base station to the packet transfer apparatus, with reference to a UL transmission timestamp included in the header information and reception time at which the uplink packet is received by the packet transfer apparatus.

Specifically, the delay evaluation section 107 of the allowable time determination means 12 specifies the second delay time with reference to (i) the transmission time which is indicated by UL Sending Timestamp (UL transmission time stamp) in UL PDU SESSION INFORMATION (PDU Type 1) in the GTP extension header and at which the uplink packet is transmitted by the gNB and (ii) the reception time recorded in the step S12 (S21). For example, a difference between the reception time at which the uplink packet is received and the transmission time at which the uplink packet is transmitted by the gNB is regarded as the second delay time.

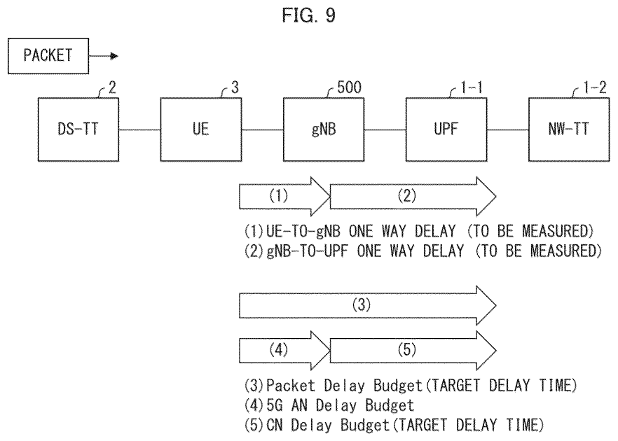

FIG. 9 is a diagram for describing a delay time and a target delay time which are specified by the delay evaluation section 107. The one-way delay time in a path from the UE to the gNB indicated in (1) in FIG. 9 corresponds to the first delay time described above, and the one-way delay time in a path from the gNB to the UPF indicated in (2) in FIG. 9 corresponds to the second delay time described above.

Subsequently, the delay evaluation section 107 of the allowable time determination means 12 derives a target delay time (S22). The delay evaluation section 107 refers to the target delay time information table 103, and refers to an allowable delay time in the path from the UE to the gNB and an allowable delay time in the path from the gNB to the UPF, each of which allowable delay times corresponds to a QoS flow ID given to a GTP extension header of the corresponding uplink packet. These values are set in advance in the target delay time information table 103. For example, a value that is 80% of a fixed value defined under TS23.501 of 3GPP is used as a target value.

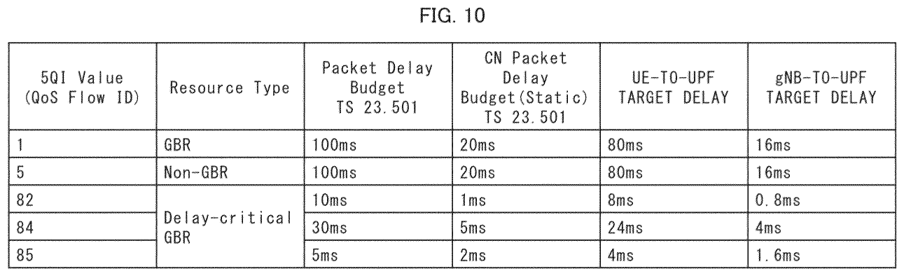

FIG. 10 is a diagram illustrating an example of target delay times set in the target delay time information table 103. As illustrated in FIG. 10, a resource type, a packet delay budget, a CN packet delay budget, a UE-to-UPF target delay, and a gNB-to-UPF target delay are set for each QoS flow ID. The resource type represents a type of packet, such as a guaranteed bit rate (GBR) and a low-delay GBR.

The packet delay budget indicated in (3) in FIG. 9 corresponds to the packet delay budget indicated in FIG. 10 and represents a target delay time in the path from the UE to the UPF. The 5G AN delay budget indicated in (4) in FIG. 9 represents a target delay time in the path from the UE to the gNB. The CN packet delay budget indicated in (5) in FIG. 9 corresponds to the CN packet delay budget indicated in FIG. 10 and represents a target delay time in the path from the gNB to the UPF.

As illustrated in FIG. 10, a value that is 80% of the packet delay budget is set as the UE-to-UPF target delay. Also as illustrated in FIG. 10, a value that is 80% of the CN packet delay budget is set as the gNB-to-UPF target delay.

Subsequently, the delay evaluation section 107 of the allowable time determination means 12 determines the allowable time of delay by comparing a sum of the first delay time and the second delay time with a target delay time. For example, the delay evaluation section 107 of the allowable time determination means 12 determines that the allowable time of delay is a value obtained by subtracting, from a target delay time, a sum of the first delay time and the second delay time.

The delay evaluation section 107 determines whether or not the allowable time of delay is not more than a predetermined value. For example, in a case where the predetermined value is 0, the delay evaluation section 107 determines whether or not the delay time (the sum of the first delay time and the second delay time) is not more than the target delay time (S23). In a case where the delay time is not more than the target delay time (the allowable time of delay is not less than the predetermined value “0”) (S23, Yes), the process is ended.

In a case where the delay time is more than the target delay time (the allowable time of delay is less than the predetermined value “0”) (S23, No), the delay evaluation section 107 records, in the session information table 102, information that the session is a session in which the uplink packet does not have a sufficient delay time (S24), and ends the process.

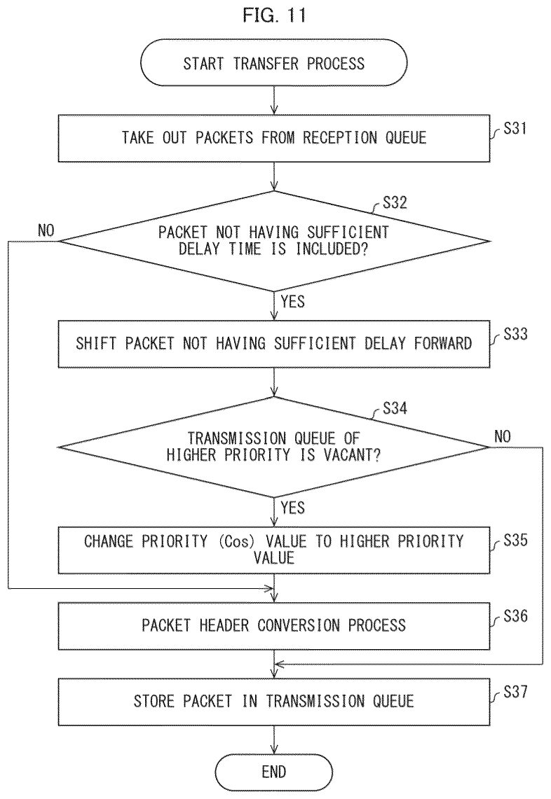

FIG. 11 is a flowchart for describing details of the transfer process (S17) illustrated in FIG. 7. Firstly, the first transfer processing section 111 takes out, in the unit of a plurality of packets (e.g. 16 packets) at a time, the packet data stored in the reception queue 109 (S31).

Subsequently, the first transfer processing section 111 determines whether or not the plurality of packets thus taken out include packet data in which a flag “1” indicating that the QoS does not allow for a sufficient delay time is set (S32). In a case where there is no packet data that does not have a sufficient delay time (S32, No), the process proceeds to a step S36.

In a case where there is packet data that does not have a sufficient delay time (S32, Yes), the first transfer processing section 111 of the order determination means 13 reverses an order of transmission of uplink packets one of which is earlier in the order of transmission and has a relatively long allowable time of delay and the other of which is later in the order of transmission and has a relatively short allowable time of delay. For example, the first transfer processing section 111 shifts a packet not having a sufficient delay time (e.g. a packet having an allowable time of delay of not more than 0) forward (causes the packet to be earlier in the order) and causes a packet having a sufficient delay time (e.g. a packet having an allowable time of delay of not less than 0) to be later in the order (S33).

The first transmission section 113 and the second transmission section 114 respectively include (i) a plurality of transmission queues (transmission queue means) 113-1 which are provided so as to correspond to priorities of packets and in which packets to be transmitted are stored and (ii) a plurality of transmission queues (transmission queue means) 114-1 which are provided so as to correspond to priorities of packets and in which packets to be transmitted are stored.

An uplink packet in the TSN network is constituted by an Ethernet (registered trademark) frame, in which CoS (Class of Service) is set in a TAG field. This CoS value indicates a priority of the uplink packet. Basically, the first transfer processing section 111 and the second transfer processing section 112 each determine, in accordance with the CoS value, a transmission queue of which priority a packet should be stored in.

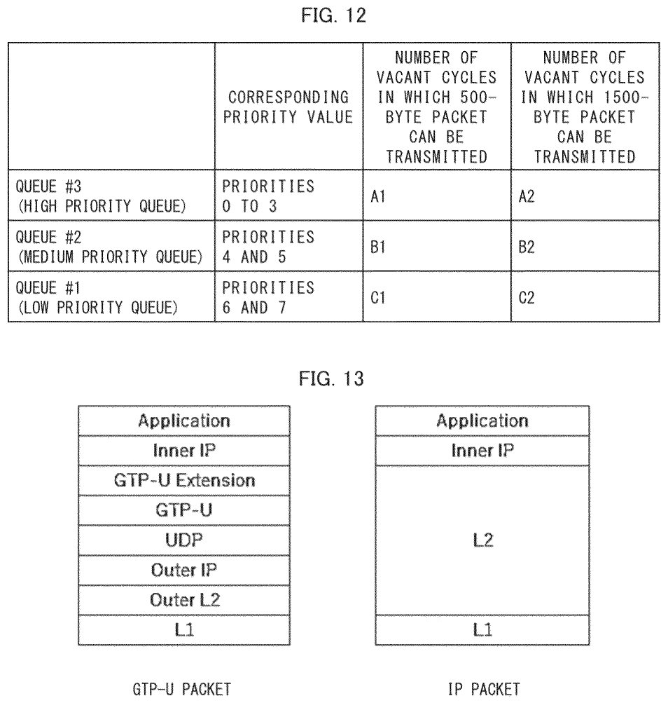

FIG. 12 is a diagram illustrating an example configuration of the transmission queues 113-1 and the transmission queues 114-1 of the first transmission section 113 and the second transmission section 114. As illustrated in FIG. 12, the transmission queues 113-1 and the transmission queues 114-1 each have queues #1 to #3, and the queue #3 is a high priority queue, the queue #2 is a medium priority queue, and the queue #1 is a low priority queue.

In accordance with the above-described CoS value, a priority is given to the packet. Here, any one of priorities 0 to 7 is set. Priority 0 has the highest priority, and priority 7 has the lowest priority. Packets with priorities 0 through 3 are stored in the high priority queue #3, packets with priorities 4 and 5 are stored in the medium priority queue #2, and packets with priorities 6 and 7 are stored in the low priority queue #1.

Further, the queues #1 to #3 each have information indicative of a vacancy status. For example, in the queue #3, the number A1 of vacant cycles in which a 500-byte packet can be transmitted and the number A2 of vacant cycles in which a 1500-byte packet can be transmitted are stored.

The first transfer processing section 111 of the order determination means 13 carries out scheduling in an order thus reversed of the uplink packets and stores each of the uplink packets in any one of the plurality of transmission queues (transmission queue means).

In a case where an allowable time of delay of an uplink packet is not more than the predetermined value, the first transfer processing section 111 of the order determination means 13 determines whether or not a transmission queue (transmission queue means) corresponding to a priority higher than a priority pre-given to the uplink packet is vacant (S34). In a case where the transmission queue is vacant (S34, Yes), the first transfer processing section 111 changes the priority (Cos) value to a higher priority value (S35).

Subsequently, the first transfer processing section 111 carries out an action, such as a header conversion process, on the uplink packet with reference to the session information table 102 (S36), and stores the uplink packet in a transmission queue 113-1 or a transmission queue 114-1. At this time, the first transfer processing section 111 of the order determination means 13 stores the uplink packet in a transmission queue (transmission queue means) corresponding to the higher priority to which the priority has been changed (S37).

FIG. 13 is a diagram illustrating formats of a GTP-U packet and an IP packet. The GTP-U packet has application, inner IP, GTP-U extension, GTP-U, user datagram protocol (UDP), outer IP, outer L2, and L1 (layer 1). The IP packet has application, inner IP, L2, and L1.

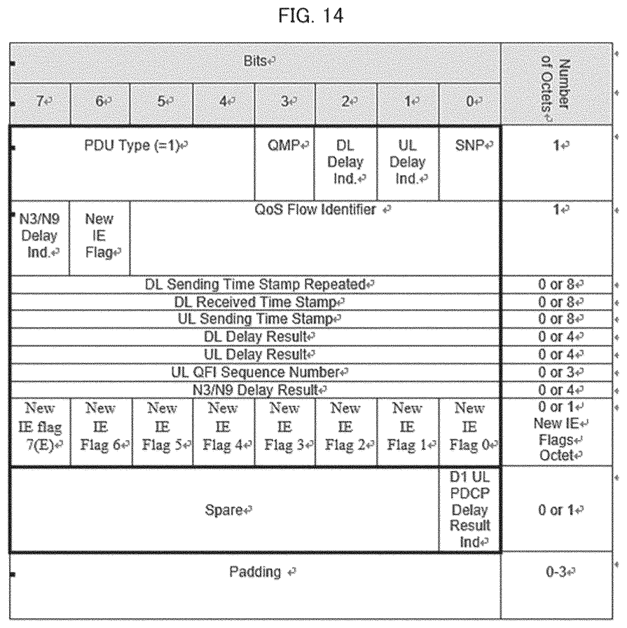

FIG. 14 is a diagram illustrating a GTP extension header. The packet transfer apparatus 1A in accordance with the present example embodiment uses only the UL sending Timestamp (UL transmission time stamp) and UL Delay Result (UL delay result) in UL PDU SESSION INFORMATION (PDU Type 1) illustrated in FIG. 14. Detailed description other than the above is not given on the GTP extension header.

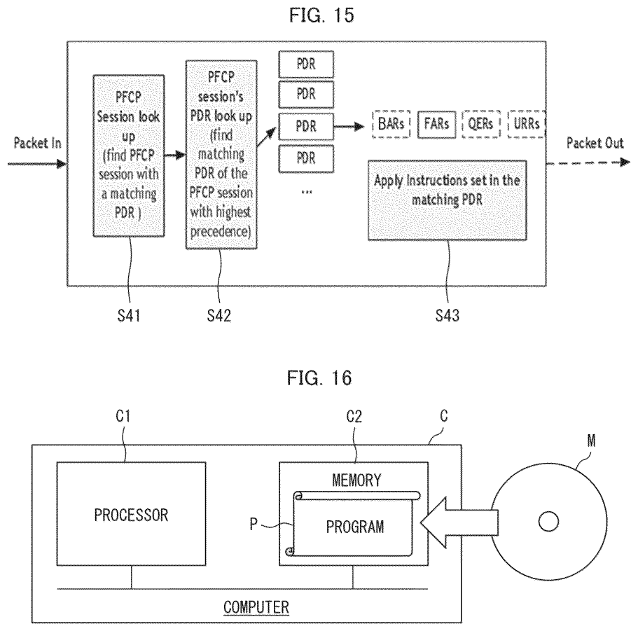

FIG. 15 is a diagram for describing a session process in UPF 1-1. The UPF 1-1 carries out a process corresponding to the PFCP session look up defined under TS29.244 (S41) and carries out a process corresponding to the packet detection rule (PDR) look up defined under TS29.244 (S42). In PFCP, packet processing is made possible mainly on the basis of PDR with combining various rules: forwarding action rule (FAR); buffering action rule (BAR); QoS enforcement rule (QER); and usage reporting rule (URR). In a case where the packet meets the conditions of PDR, packet processing is carried out in accordance with a group of rules defined (S43).

<Example Advantage of Packet Transfer Apparatus 1A in Accordance with Second Example Embodiment>

As described above, according to packet transfer apparatus 1A in accordance with the present example embodiment, the delay evaluation section 107 determines an allowable time of delay by comparing a sum of the first delay time and the second delay time with a target delay time. This makes it possible to easily determine the allowable time of delay.

Further, the delay evaluation section 107 determines that the allowable time of delay is a value obtained by subtracting, from the target delay time, the sum of the first delay time and the second delay time. This makes it possible to easily determine the allowable time of delay.

Further, the first transfer processing section 111 reverses an order of transmission of uplink packets one of which is earlier in the order of transmission and has a relatively long allowable time of delay and the other of which is later in the order of transmission and has a relatively short allowable time of delay. This allows the uplink packet having a relatively short allowable time of delay to have priority in being transmitted.

Further, the first transfer processing section 111 carries out scheduling in a reversed order of the uplink packets and stores each of the uplink packets in any one of the plurality of queues #1 to #3. This allows the uplink packet having a relatively short allowable time of delay to be given priority in scheduling.

Further, in a case where an allowable time of delay of an uplink packet is not more than a predetermined value, the first transfer processing section 111 changes a priority pre-given to the uplink packet to an even higher priority. This allows the uplink packet whose allowable time of delay is not more than the predetermined value to have an even higher priority in being transmitted.

Further, in a case where an allowable time of delay of an uplink packet is not more than the predetermined value and a queue corresponding to a priority higher than a priority pre-given to the uplink packet is vacant, the first transfer processing section 111 changes the priority of the uplink packet to the higher priority and stores the uplink packet in the queue corresponding to the higher priority. This makes it possible to suitably transmit the uplink packet whose allowable time of delay is not more than the predetermined value.

### [Software Implementation Example]

Some or all of functions of the packet transfer apparatuses 1 and 1A can be realized by hardware such as an integrated circuit (IC chip) or can be alternatively realized by software.

In the latter case, the packet transfer apparatuses 1 and 1A are realized by, for example, a computer that executes instructions of a program that is software realizing the foregoing functions. FIG. 16 illustrates an example of such a computer (hereinafter referred to as a “computer C”). The computer C includes at least one processor C1 and at least one memory C2. The at least one memory C2 stores a program P for causing the computer C to operate as each of the packet transfer apparatuses 1 and 1A. In the computer C, the functions of the packet transfer apparatuses 1 and 1A are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random RAM in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. Such a transmission medium may be, for example, a communication network, a broadcast wave, or the like. The computer C can acquire the program P also via the transmission medium.
[Additional remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.
[Additional remark 2]

The whole or part of the example embodiments disclosed above can also be described as below. Note, however, that the present invention is not limited to the following supplementary notes.
(Supplementary note 1)

A packet transfer apparatus, including:
an acquisition means that acquires an uplink packet received from a terminal apparatus;
an allowable time determination means that determines, with reference to time information included in header information of the uplink packet, an allowable time of delay of the uplink packet; and
an order determination means that determines, on the basis of the allowable time of delay, an order of transmission of the uplink packet.

According to the above configuration, the order determination means determines an order of transmission of an uplink packet on the basis of an allowable time of delay. This makes it possible to transfer packets in an appropriate order on the basis of time information of the packets.
(Supplementary note 2)

The packet transfer apparatus described in supplementary note 1, wherein the allowable time determination means
specifies a first delay time with reference to UL delay result information included in the header information, the first delay time being a time of delay in a path from the terminal apparatus to a base station,
specifies a second delay time with reference to a UL transmission timestamp included in the header information and a receipt time at which the uplink packet is received by the packet transfer apparatus, the second delay time being a time of delay in a path from the base station to the packet transfer apparatus, and
determines the allowable time of delay by comparing a sum of the first delay time and the second delay time with a target delay time.

According to the above configuration, the allowable time determination means determines an allowable time of delay by comparing a sum of the first delay time and the second delay time with a target delay time. This makes it possible to easily determine the allowable time of delay.
(Supplementary note 3)

The packet transfer apparatus described in supplementary note 2, wherein the allowable time determination means
determines that the allowable time of delay is a value obtained by subtracting, from the target delay time, the sum of the first delay time and the second delay time.

According to the above configuration, the allowable time determination means determines that the allowable time of delay is a value obtained by subtracting, from the target delay time, the sum of the first delay time and the second delay time. This makes it possible to easily determine the allowable time of delay.
(Supplementary note 4)

The packet transfer apparatus according to any one of supplementary notes 1 to 3, wherein the order determination means
reverses an order of transmission of uplink packets one of which is earlier in the order of transmission and has a relatively long allowable time of delay and the other of which is later in the order of transmission and has a relatively short allowable time of delay.

The above configuration allows the uplink packet having a relatively short allowable time of delay to have priority in being transmitted.
(Supplementary note 5)

The packet transfer apparatus described in supplementary note 4, further including a plurality of transmission queue means which are provided so as to correspond to priorities of packets and in each of which a packet to be transmitted is stored,
wherein the order determination means
   carries out scheduling in an order thus reversed of the uplink packets and stores each of the uplink packets in any one of the plurality of transmission queue means.

The above configuration allows the uplink packet having a relatively short allowable time of delay to be given priority in scheduling.
(Supplementary note 6)

The packet transfer apparatus described in supplementary note 5, wherein the order determination means
changes a priority pre-given to an uplink packet to a higher priority in a case where an allowable time of delay of the uplink packet is not more than a predetermined value.

The above configuration allows the uplink packet whose allowable time of delay is not more than the predetermined value to have an even higher priority in being transmitted.
(Supplementary note 7)

The packet transfer apparatus described in supplementary note 6, wherein the order determination means
stores the uplink packet in a transmission queue means corresponding to the higher priority to which the priority has been changed.

The above configuration allows the uplink packet whose allowable time of delay is not more than the predetermined value to have an even higher priority in being transmitted.
(Supplementary note 8)

The packet transfer apparatus described in any one of supplementary notes 5 to 7, wherein in a case where an allowable time of delay of an uplink packet is not more than a predetermined value and a transmission queue means corresponding to a priority higher than a priority pre-given to the uplink packet is vacant, the order determination means changes the priority of the uplink packet to the higher priority and stores the uplink packet in the transmission queue means corresponding to the higher priority.

According to the above configuration, it is possible to suitably transmit the uplink packet whose allowable time of delay is not more than the predetermined value.
(Supplementary note 9)

The packet transfer apparatus described in any one of supplementary notes 1 to 8, wherein the header information of the uplink packet is information given to a GTP extension header.
(Supplementary note 10)

A packet transfer method, including the steps of:
acquiring an uplink packet received from a terminal apparatus;
determining, with reference to time information included in header information of the uplink packet, an allowable time of delay of the uplink packet; and
determining, on the basis of the allowable time of delay, an order of transmission of the uplink packet.

According to the above configuration, an order of transmission of an uplink packet is determined on the basis of an allowable time of delay. This makes it possible to transfer packets in an appropriate order on the basis of time information of the packets.
(Supplementary note 11)

A program for causing a computer to carry out:
a process of acquiring an uplink packet received from a terminal apparatus;
a process of determining, with reference to time information included in header information of the uplink packet, an allowable time of delay of the uplink packet; and
a process of determining, on the basis of the allowable time of delay, an order of transmission of the uplink packet.

According to the above configuration, an order of transmission of an uplink packet is determined on the basis of an allowable time of delay. This makes it possible to transfer packets in an appropriate order on the basis of time information of the packets.
(Supplementary note 12)

A packet transfer apparatus, including at least one processor, the at least one processor carrying out:
a process of acquiring an uplink packet received from a terminal apparatus;
a process of determining, with reference to time information included in header information of the uplink packet, an allowable time of delay of the uplink packet; and
a process of determining, on the basis of the allowable time of delay, an order of transmission of the uplink packet.

Note that the packet transfer apparatus can further include a memory. The memory can store a program for causing the processor to carry out the process of acquiring the uplink packet, the process of determining the allowable time of delay, and the process of determining the order of transmission. Further, the program can also be stored in a computer-readable non-transitory tangible storage medium.

### REFERENCE SIGNS LIST

1, 1A: Packet transfer apparatus (UPF/NW-TT)
2: DS-TT
3: UE
4: (R)AN
5: AMF
6: SMF
7: PCF
8: TSN AF
9: UDM
10: NEF
11: Acquisition means
12: Allowable time determination means
13: Order determination means
101: PFCP control section
102: Session information table
103: Target delay time information table
104: First reception port
105: Second reception port
106: Analysis section
107: Delay evaluation section
108: Distribution section
109: Reception queue for low delay
110: Reception queue for non-low delay
111: First transfer processing section
112: Second transfer processing section
113: First transmission section
114: Second transmission section
115: First transmission port
116: Second transmission port

What is claimed is:

1. A packet transfer apparatus, comprising at least one processor, the at least one processor:
acquiring an uplink packet received from a terminal apparatus;
determining, with reference to time information included in header information of the uplink packet, an allowable time of delay of the uplink packet; and
determining, on the basis of the allowable time of delay, an order of transmission of the uplink packet.

2. The packet transfer apparatus according to claim 1, wherein in the determining of the allowable time of delay, the at least one processor
specifies a first delay time with reference to UL delay result information included in the header information, the first delay time being a time of delay in a path from the terminal apparatus to a base station,
specifies a second delay time with reference to a UL transmission timestamp included in the header information and a receipt time at which the uplink packet is received by the packet transfer apparatus, the second delay time being a time of delay in a path from the base station to the packet transfer apparatus, and
determines the allowable time of delay by comparing a sum of the first delay time and the second delay time with a target delay time.

3. The packet transfer apparatus according to claim 2, wherein in the determining of the allowable time of delay, the at least one processor
determines that the allowable time of delay is a value obtained by subtracting, from the target delay time, the sum of the first delay time and the second delay time.

4. The packet transfer apparatus according to claim 1, wherein in the determining of the order of transmission, the at least one processor
reverses an order of transmission of uplink packets one of which is earlier in the order of transmission and has a relatively long allowable time of delay and the other of which is later in the order of transmission and has a relatively short allowable time of delay.

5. The packet transfer apparatus according to claim 4, further comprising a plurality of transmission queues which are provided so as to correspond to priorities of packets and in each of which a packet to be transmitted is stored,
wherein in the determining of the order of transmission, the at least one processor
carries out scheduling in an order thus reversed of the uplink packets and stores each of the uplink packets in any one of the plurality of transmission queues.

6. The packet transfer apparatus according to claim 5, wherein in the determining of the order of transmission, the at least one processor
changes a priority pre-given to an uplink packet to a higher priority in a case where an allowable time of delay of the uplink packet is not more than a predetermined value.

7. The packet transfer apparatus according to claim 6, wherein in the determining of the order of transmission, the at least one processor
stores the uplink packet in a transmission queue corresponding to the higher priority to which the priority has been changed.

8. The packet transfer apparatus according to claim 5, wherein, in the determining of the order of transmission, in a case where the allowable time of delay of an uplink packet is not more than a predetermined value and a transmission queue corresponding to a priority higher than a priority pre-given to the uplink packet is vacant, the at least one processor changes the priority of the uplink packet to the higher priority and stores the uplink packet in the transmission queue corresponding to the higher priority.

9. The packet transfer apparatus according to claim 1, wherein the header information of the uplink packet is information given to a GTP extension header.

10. A packet transfer method, comprising the steps of:
acquiring an uplink packet received from a terminal apparatus;
determining, with reference to time information included in header information of the uplink packet, an allowable time of delay of the uplink packet; and
determining, on the basis of the allowable time of delay, an order of transmission of the uplink packet.

11. (canceled)

12. The packet transfer method according to claim 10, wherein the step of determining the allowable time of delay includes
specifying a first delay time with reference to UL delay result information included in the header information, the first delay time being a time of delay in a path from the terminal apparatus to a base station,
specifying a second delay time with reference to a UL transmission timestamp included in the header information and a receipt time at which the uplink packet is received by the packet transfer apparatus, the second delay time being a time of delay in a path from the base station to the packet transfer apparatus, and
determining the allowable time of delay by comparing a sum of the first delay time and the second delay time with a target delay time.

13. The packet transfer method according to claim 12, wherein the step of determining the allowable time of delay includes
determining that the allowable time of delay is a value obtained by subtracting, from the target delay time, the sum of the first delay time and the second delay time.

14. The packet transfer method according to claim 10, wherein the step of determining the order of transmission includes
reversing an order of transmission of uplink packets one of which is earlier in the order of transmission and has a relatively long allowable time of delay and the other of which is later in the order of transmission and has a relatively short allowable time of delay.

15. The packet transfer method according to claim 14, wherein the step of determining the order of transmission includes
carrying out scheduling in an order thus reversed of the uplink packets and storing each of the uplink packets in any one of a plurality of transmission queues which are provided so as to correspond to priorities of packets and in each of which a packet to be transmitted is stored.

16. The packet transfer method according to claim 15, wherein the step of determining the order of transmission includes
changing a priority pre-given to an uplink packet to a higher priority in a case where an allowable time of delay of the uplink packet is not more than a predetermined value.

17. The packet transfer method according to claim 16, wherein the step of determining the order of transmission includes
storing the uplink packet in a transmission queue corresponding to the higher priority to which the priority has been changed.

18. The packet transfer method according to claim 15, wherein the step of determining the order of transmission includes,
in a case where an allowable time of delay of an uplink packet is not more than a predetermined value and a transmission queue corresponding to a priority higher than a priority pre-given to the uplink packet is vacant, changing the priority of the uplink packet to the higher priority and storing the uplink packet in the transmission queue corresponding to the higher priority.

19. The packet transfer method according to claim 10, wherein the header information of the uplink packet is information given to a GTP extension header.

20. A non-transitory storage medium, storing therein a program for causing a computer to:
acquire an uplink packet received from a terminal apparatus;
determine, with reference to time information included in header information of the uplink packet, an allowable time of delay of the uplink packet; and
determine, on the basis of the allowable time of delay, an order of transmission of the uplink packet.
